(19) United States
(12) Patent Application Publication
(10) Pub. No.: US 2014/0114991 A1
(43) Pub. Date: Apr. 24, 2014

(54) PROVIDING ACCESS TO INFORMATION

(71) Applicants: Robert Campbell, Cupertino, CA (US); Steven C. Lemke, Sunnyvale, CA (US)

(72) Inventors: Robert Campbell, Cupertino, CA (US); Steven C. Lemke, Sunnyvale, CA (US)

(21) Appl. No.: 14/127,581

(22) PCT Filed: Jul. 1, 2011
(86) PCT No.: PCT/US2011/042748

§ 371 Date: Dec. 19, 2013

(51) Int. Cl. G06F 21/62; G06F 17/30

(52) U.S. Cl. CPC G06F 21/6218; G06F 17/30424
USPC 707/754; 707/781; 707/769

(57) ABSTRACT

Example embodiments disclosed herein relate to providing access to information. A profile is determined. The profile is used to provide access to account specific information to an application.

### BACKGROUND

Personal computing devices are directed towards the needs of individual users. Increasingly, computing devices are making their way from users' desks to social areas. For example, many families today have a home theater personal computer in their living room. Further, many families share their home desktop or laptop with other family members or guests.

### BRIEF DESCRIPTION OF THE DRAWINGS

The following detailed description references the drawings, wherein:

FIGS. 1A and 1B are block diagrams of devices for providing access to information, according to various examples;

FIG. 2 is a flowchart of a method for providing access to information, according to one example;

FIG. 3 is a flowchart of a method for dynamically providing access to information, according to one example;

FIG. 4 is a block diagram of a computing device for determining account specific information, according to one example; and

FIG. 5 is a block diagram of an approach for providing access to information in a database, according to one example.

### DETAILED DESCRIPTION

Computing devices are increasingly being used socially, for example, in a family environment. Typically, users of home systems share a single operating system login between individuals. For example, a family may share use of a home theater personal computer, a laptop, etc. between family members. As such, family members and/or guests may take turns using a computing device during the course of a day.

On many occasions users use an operating system login between users because it is inconvenient to log out of an operating system account and then log back into another operating system account to switch users. As such, when using the system, users may log into and out of service accounts (e.g., email, retail websites, social media, etc.) using web browsers or other applications. Sometimes users of the computing device may use separate web browsers to segregate user information. This approach helps facilitate customization of applications and services to a user. For example, a first user can use a first web browser and leave accounts logged in while a second user uses a second web browser and leaves accounts logged in. As such, when the second user uses the second web browser, cookies utilized to provide a customized user experience are specific to the second user. However, these approaches lack providing privacy for the users of the device.

Accordingly, various embodiments disclosed herein relate to providing an approach to accessing information. Users may utilize applications on a device to receive services, entertainment, information, or the like. In certain embodiments, an application is a program designed to help a user perform one or more tasks. Examples of applications include email, browsers, calendar programs, office suites, text editing programs, games, contact management programs, etc. The applications may access account specific information to facilitate performance of tasks. In some embodiments, account specific information is data that is provided by a service that is associated with an account. Examples of account specific information for an email application includes emails, email contact information, email subject lines, etc. Other examples of account specific information include contact information, sets of browser cookies, saved game information, and calendar information.

Middleware can be used to determine access of one or more applications to account specific information. In one example, a profile can be created for one or more users of the device. Further, a shared profile can be created. In a default accessibility mode, the shared profile is used. The shared profile can allow a user to access shared account specific information. In certain examples, shared account specific information is account specific information that is designated to be available to all users of the device. In certain examples, profiles include user account information to facilitate customization of user experience. User account information may include an identifier of one or more accounts that can be accessed by a user of the profile. Further, the user account information may include authentication information for the specific accounts.

A profile of a user can be selected to determine what type of access to provide to the user. Users can be authenticated using one or more approaches to determine the profile. As noted above, a non-authenticated default mode can also be utilized. In one example, a profile user name and/or password prompt can be provided on the user interface (e.g., on a desktop background) to allow a user to provide authentication. Similarly, a logout button can be provided. Other methods of authentication can also be utilized, for example, biometric input (e.g., fingerprint, facial recognition, iris scan, palm scan, etc.), security tokens, pin code input, docking of a personal device (e.g., a cellular phone, a thumb drive including security information, etc.), or combinations thereof. Various authentication schemes can also be used to determine when a user should be logged off. For example, when a user is logged on using facial recognition or another body type recognition, when the user leaves the area, the user can be logged out.

When a profile is selected, the account specific information corresponding to the profile is provided to applications the user utilizes. This type of account specific information can be considered unshared account specific information. In certain scenarios, unshared account specific information is account specific information that is not part of the shared account specific information. As such, unshared account specific information can be, in certain examples, associated with multiple profiles. Further, the shared account specific information can also be provided to the applications. Thus, the user can utilize applications customized for the user. Moreover, because profiles can be quickly changed, customization of the applications can be quickly changed. Additionally, information from multiple accounts can be compiled and provided to applications. As such, a single user interface can be used to retrieve information associated with an application even if the information is associated with more than one account.

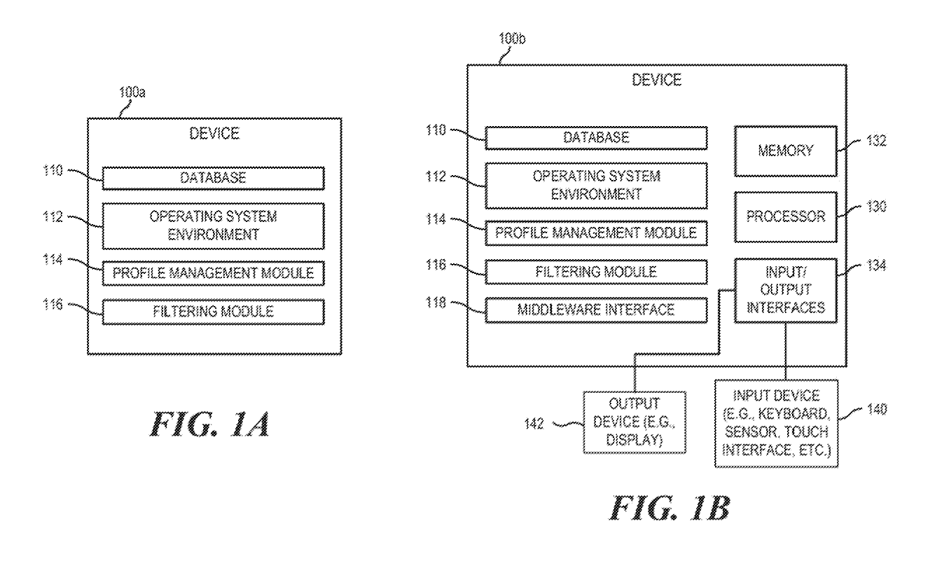

Referring now to the drawings, FIGS. 1A and 1B are block diagrams of devices for providing access to information, according to various examples. Devices 100a, 100b include components that can be utilized to filter access of a database in an operating system environment. The respective devices 100a, 100b may be a notebook computer, a desktop computer, a tablet computing device, a wireless device, a server, a workstation, or any other computing device that provides access to applications.

The respective devices 100a, 100b can be used by multiple users. Further, the respective devices 100a, 100b can include a database 110 that includes shared account specific information and unshared account specific information respectively associated with a plurality of accounts. In certain scenarios, the database 110 can be located externally (e.g., on a cloud or server). Moreover, the database 110 can include information retrieved from sources external to the device 100. For example, the database 110 can include one or more emails retrieved from one or more email servers, contact information, calendar information, or the like.

The device 100 can include an operating system environment 112, in one embodiment, the operating system environment 112 is the setting provided by an operating system. In certain scenarios, the operating system is programs and data that runs on the device 100, manages hardware resources, and provides common services for execution of various applications. As such, the operating system acts as an intermediary between applications and hardware of the device 100. Thus, the operating system environment 112 can include one or more applications executing via the operating system. Examples of applications include email, browsers, calendar programs, office suites, document programs, games, contact management programs, etc.

A profile management module 114 can be used to determine an active profile. In certain scenarios, the active profile can be a default or shared profile when no particular user or specific profile is used. In other scenarios, the active profile can be specific to a user. One or more authentication methods can be used to determine which profile is active. For example, a user can be authenticated based on a username/password, biometric data, a security tag, mobile device docking, etc. In some cases, authentication information (e.g., a username/password set, biometric information, mobile device identifier, etc.) can be stored at the device 100 and associated with a profile in one or more data structures. Then, when input authentication information is provided to the device (e.g., a facial scan, username/password, etc.), the input authentication information can be compared to the authentication information to determine the active profile. Other technologies and approaches can be used to determine which profile is active.

Further, a filtering module 116 can be used to filter access of the unshared account specific information to the applications based on the active profile. As noted above, applications executing on the device 100 can request information from the database 110. For example, an application (e.g., an email application) may request a set of information (e.g., emails) from the database 110. The database 110 can be filtered by the filtering module 116 to provide access to the application based on the active profile. This can be implemented by determining one or more accounts that are associated with the active profile and filtering the information in such a manner that the accounts that are unassociated with the active profile are filtered from the information provided to the application.

In one example, the active profile is a guest profile (e.g., a default profile, a shared profile, etc.). As such, shared account specific information can be provided to the application requesting information from the database 110. The guest profile can point to one or more accounts associated with the shared account specific information. As such, when an application requests information from the database 110, the unshared account specific information is filtered out of the information provided to the application by the filtering module 116. In certain scenarios, the shared account specific information is further provided to users with other profiles.

Users with specific profiles can receive the information associated with the shared profile as well as information associated with accounts specific to the profile. In one example, a particular profile has been determined as being active (e.g., based on authentication). The profile is associated with a set of accounts. For example, the profile may be associated with three email accounts (e.g., a home junk email accounts (e.g., a personal email account, and a work email account), two calendar accounts (e.g., a home calendar and a work calendar), and two instant messaging accounts (e.g., a home account and a work account). Access to the unshared account specific information associated with the set is provided to applications requesting information from the database 110.

In one example, one of the applications is an email application. The email application can be set up to communicate with the database 110 via a middleware interface 118. In this example, the unshared account specific information includes electronic mail storage respectively associated with the email accounts. The database 110 can further include additional electronic mails associated with other accounts. The middleware interface 118 can use the filtering module 116 and the profile management module 114 to retrieve information from the database 110. The middleware interface 118 can further be part of the operating system environment 112. The email application requests email information from the middleware interface 118. The middleware interface 118 determines the active profile. Then, the middleware interface 118 retrieves email information associated with the email accounts corresponding to the active profile from the database 110. This can be implemented by having the filtering module 116 filter out the electronic mail storage available to the email application based on one or more of the accounts corresponding to the active profile. Further, the filtering module 116 can allow for email information associated with email counts associated with the shared profile to be accessible. In certain scenarios, middleware interface 118 can cause the database 110 to be updated. Moreover, the database 110 can be updated using stored account information. Because the email application has information from each of the email accounts, the email application can present the entails in a single interface.

In another example, the application is a calendar application. The application requests calendar information from the middleware interface 118. The middieware interface determines that the active profile is associated with the home calendar and the work calendar. The active profile then allows access to the database 110 for the home calendar and the work calendar via the filtering module 116. Further, the middleware interface 118 can incorporate information from both calendars to provide a single calendar including the home calendar and the work calendar to the calendar application. Similarly, a contacts managing application, an instant messaging application, etc. can request information from the middleware interface. Moreover, in certain scenarios, login information associated with one or more of the applications can be stored using the profile management module 114 to allow for services to be provided based on the active profile.

Further, the application can provide other services to users. For example, a printer application can provide access to a printer based on the active profile. In one example, two printers may be connected to the device 100. A first printer may be shared and information to access the printer may be stored in the shared information. A second printer may be a work printer and be associated with an account. Users not associated with the account would not be provided access to the second printer. In certain scenarios, this can be accomplished by storing information to access the second printer in a database associated with the second account. Further, in certain examples, the database can be separated from other databases and stored in another location, for example, at the second printer. In a similar manner, other peripheral devices and/or services (e.g., video conferencing, baby monitoring, etc.) may utilize this approach to access information.

A processor 130, such as one or more central processing units (CPUs), graphical processing units, or microprocessors suitable for retrieval and execution of instructions and/or electronic circuits can be configured to perform the functionality of any of the modules 112, 114, 116, 118. In certain scenarios, instructions and/or other information, such as database information, can be included in memory 132 or other memories. Input/output interfaces 134 may additionally be provided by the computing device 100b. For example, input devices 140, such as a keyboard, a sensor (e.g., a camera, a biometric sensor, etc.), a touch interface, a mouse, a microphone, etc. can be utilized to receive input from an environment surrounding the computing device 100b. Further, an output device 142, such as a display, can be utilized to present information to users. Examples of output devices include speakers, display devices, amplifiers, etc. Moreover, in certain embodiments, some components can be utilized to implement functionality of other components.

Each of the modules 112-118 may include, example, hardware devices including electronic circuitry for implementing the functionality described below. In addition or as an alternative, each module 112-118 may be implemented as a series of instructions encoded on a machine-readable storage medium of computing device 100 and executable by processor 130. It should be noted that, in some embodiments, some modules are implemented as hardware devices, while other modules are implemented as executable instructions.

In certain scenarios, the device 100 is physically accessible by the user. For example, the device 100 can be a tablet, a desktop computer, a laptop computer, etc. In other scenarios, the device 100 is a background platform with communications abilities, for example, a server. In this scenario, the server provides the database and information to a terminal (e.g., desktop computer, a laptop computer, a tablet, etc.). As such, some of the components of the device 100 may be implemented in one device while other components of the device 100 are implemented at another device.

A communication network can use wired communications, wireless communications, or combinations thereof to connect the device 100 to one or more services platforms (e.g., an email platform, a contacts platform, a calendar platform, other devices, etc.). Further, the communication network can include multiple sub communication networks such as data networks, wireless networks, telephony networks, etc. Such networks can include, for example, a public data network such as the Internet, local area networks (LANs), wide area networks (WANs), metropolitan area networks (MANs), cable networks, fiber optic networks, combinations thereof, or the like. In certain examples, wireless networks may include cellular networks, satellite communications, wireless LANs, etc. Various communications structures and infrastructure can be utilized to implement the communication network.

By way of example, the device 100 and one or more services platforms communicate with each other and other components with access to the communication network via a communication protocol or multiple protocols. A protocol can be a set of rules that defines how nodes of the communication network interact with other nodes. Further, communications between network nodes can be implemented by exchanging discrete packets of data or sending messages. Packets can include header information associated with a protocol (e.g., information on the location of the network node(s) to contact) as well as payload information. The middleware interface 118 may cause update of the database 110 using one or more of the services platforms. For example, the middleware interface 118 may request updated email information, calendar information, etc. from a server and update the database 110. In certain examples, passwords and/or other authentication mechanisms can be stored with the profiles and/or in the database 110 to update the database 110.

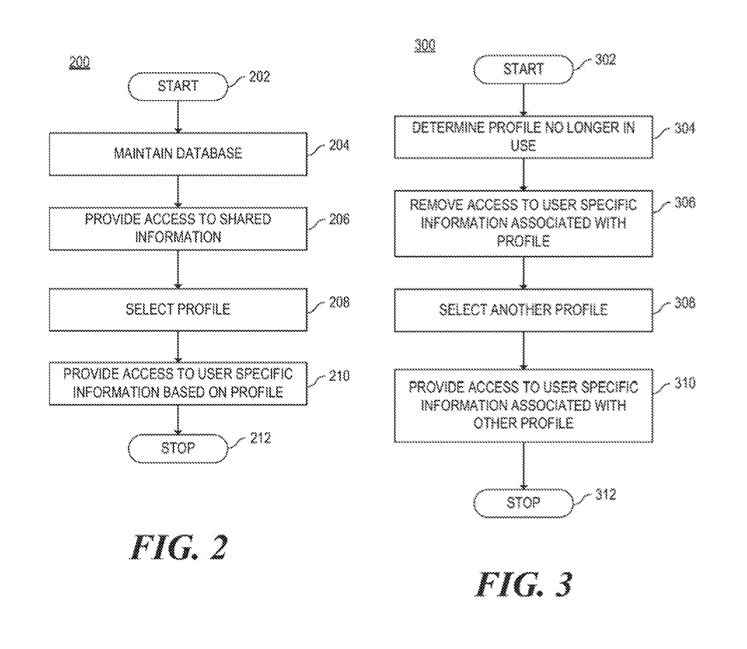

FIG. 2 is a flowchart of a method for providing access to information, according to one example. Although execution of method 200 is described below with reference to device 100, other suitable components for execution of method 200 can be utilized (e.g., computing device 400). Additionally, the components for executing the method 200 may be spread among multiple devices. Method 200 may be implemented in the form of executable instructions stored on a machine-readable storage medium, and/or in the form of electronic circuitry.

Method 200 may start at 202 and proceed to 204, where a database including shared information and use specific information respectively associated with a plurality of profiles is maintained. The database may be stored locally at a device 100 or remotely at another device (e.g., a server, a cloud platform, etc.). Further, the shared information can be shared account specific information or information specific to one or more users. The shared information can be public to users of an accessing device (e.g., the device 100, a terminal, etc.).

Moreover, user specific information can be information that is associated with a particular user, for example, based on a profile associated with the user. By way of example, shared information and/or the user specific information can include data such as contact information, sets of browser cookies, saved game information, calendar information, email information, or the like.

At 206, a middleware interface 118 provides access to the shared information to a plurality of applications executing in an operating system environment. This can occur, for example, when an operating system and/or the middleware interface 118 on the device 100 starts up. Further, this can be a default setting used at an initialization stage and/or be used when a shared profile is active. Moreover, the shared information can include information associated with one or more accounts associated with one or more of the applications. Additionally or alternatively, the user specific information can include information associated with one or more other accounts associated with the one or more applications. As noted above, the accounts can be accounts associated with user information such as calendar accounts, gaming accounts, email accounts, etc. Further, the applications can include an email application, a calendar application, a contacts application, a web browser application, or a combination thereof.

One of the profiles is selected at 208. The selection can be based on an authentication of a user. For example, the profile can be selected based on a username/password set, docking of a personal device associated with the profile, biometric information, image recognition, a wireless identifier, an electronic key, a personal identification code, combinations thereof, etc.

Then, the middleware interface 118 can provide access to user specific information associated with the profile to one or more of the applications (210). The access can be further limited based on the type of application. For example, a contacts application may receive information associated with contact information, while an email application may receive emails as well as contact information. The access to the user specific information can be controlled by filtering out the user specific information in the database for which the user associated with the profile does not have access. In certain scenarios, the access provided to the applications includes the information associated with the profile as well as the shared information. Further, the applications can receive the information in a manner such that the applications can combine information from multiple accounts to produce an integrated user interface for the user. For example, a calendar application can include calendar information from the user's work account, the user's personal account, and a shared family account. The method 200 proceeds to 212, where the method 200 stops. The device 100 can continue processing.

FIG. 3 is a flowchart of a method for dynamically providing access to information, according to one example. Method 300 can start at 302 and continue the processes initiated by method 200. At 304, a profile management module 114 can determine that the profile is no longer in use. This can occur based on an explicit action by a user (e.g., logging off of the user) or an implicit action, for example, a timeout, sensor information associated with the user, removal of an access key or docking of a personal device, etc. In the case of sensor information, a camera can be used to detect movement of the user and/or changing of users. Further, in a case where the profile was determined based on the docking of a personal device, the undocking of the personal device can indicate that the profile is no longer in use.

Then, at 306, the middleware interface 118 removes access of the user specific information associated with the profile to the applications. This can be accomplished by filtering out information associated with the profile to the applications. The applications can still be used with shared information.

Further, at 308, another one of the profiles can be selected. The other profile can be selected, for example, based on a use of the operating system environment. As noted above, one or more authentication methods or association methods can be used to determine the other profile. Then, at 310, the middleware interface 118 provides access of user specific information associated with the other profile to the applications. In this manner, as users of the device 100 change, the profiles and user experience changes. Then, at 312, the method 300 stops.

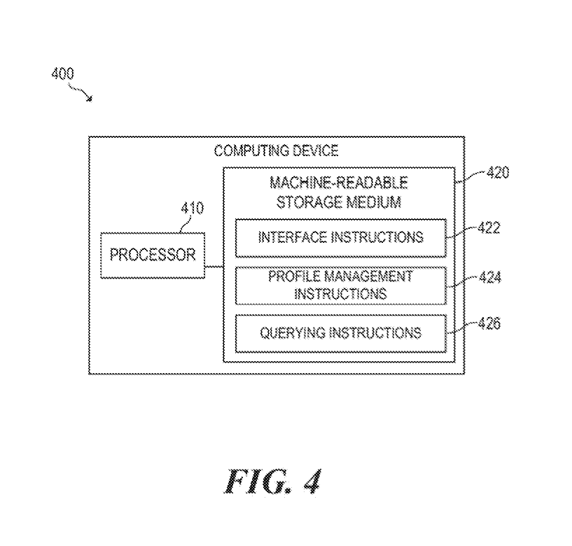

FIG. 4 is a block diagram of a computing device for determining account specific information, according to one example. The computing device 400 includes, for example, a processor 410, and a machine-readable storage medium 420 including instructions 422, 424, 426 for determining account specific information to provide to a user. Computing device 400 may be, for example, a notebook computer, a slate computing device, a portable reading device, a wireless email device, a mobile phone, or any other computing device.

Processor 410 may be, at least one central processing unit (CPU), at least one semiconductor-based microprocessor, at least one graphics processing unit (GPU), other hardware devices suitable for retrieval and execution of instructions stored in machine-readable storage medium 420, or combinations thereof. For example, the processor 410 may include multiple cores on a chip, include multiple cores across multiple chips, multiple cores across multiple devices (e.g., if the computing device 400 includes multiple node devices), or combinations thereof. Processor 410 may fetch, decode, and execute instructions 422, 424, 426 to implement methods 200 and/or 300. As an alternative or in addition to retrieving and executing instructions, processor 410 may include at least one integrated circuit (IC), other control logic, other electronic circuits, or combinations thereof that include a number of electronic components for performing the functionality of instructions 422, 424, 426.

Machine-readable storage medium 420 may be any electronic, magnetic, optical, or other physical storage device that contains or stores executable instructions. Thus, machine-readable storage medium may be, for example, Random Access Memory (RAM), an Electrically Erasable Programmable Read-Only Memory (EEPROM), a storage drive, a Compact Disc Read Only Memory (CD-ROM), and the like. As such, the machine-readable storage medium can be non-transitory. Machine-readable storage medium 420 may be encoded with a series of executable instructions for provisioning information associated with one or more accounts to users.

The computing device 400 can initialize and be brought to a state where an operating system is executing. The operating system can provide an environment where one or more applications can run. Further, a middleware program and/or a process associated with the operating system can provide access to information. For example, the applications can request information from the program and the program can determine which information to provide.

Interface instructions 422 can be executed to receive a request for account specific information from one of the applications. The program can provide an application programming interface (API) to the applications to utilize. In one example, the application is an email application. In this example, the API can be used by the email application to request account specific information (e.g., emails and/or contact information).

Further, in certain embodiments, the account specific information requested by the application can include compiled information from multiple accounts. For example, the program can provide information to the requesting application including information from multiple accounts. In the scenario of an email application, the program can provide mails from multiple sources. Further, the database can include emails from multiple sources (e.g., emails from different service providers and/or different accounts associated with the providers).

Profile management instructions $24 can be executed to determine an active profile from multiple profiles available at the computing device 400. As noted above, one or more approaches can be used to determine the active profile. For example, input can be received at the computing device 400 to determine the active profile. In certain scenarios, a default shared profile can be used if authentication is not provided or a particular user is not determined.

Querying instructions 428 can be used by the program to query a database for the account specific information based on the request and the active profile. The database can be stored at the computing device 100 or stored at an external location (e.g., a cloud or server backend) and available via a network. The database can include the account specific information. Further, the account specific information can respectively correspond to multiple accounts. For example, a first set of the account specific information can correspond to a first account while a second set of the account specific information can correspond to a second account. Moreover, the active profile can correspond to one or more of the accounts. As noted above, a profile can be associated with one or more accounts (e.g., two email accounts, three instant messaging accounts, etc.). Further, the profiles may include authentication information associated with the accounts.

In one scenario, the database includes account specific information that is open to each of the profiles. This can be shared information that can be available to any one specific profile and/or to a shared profile.

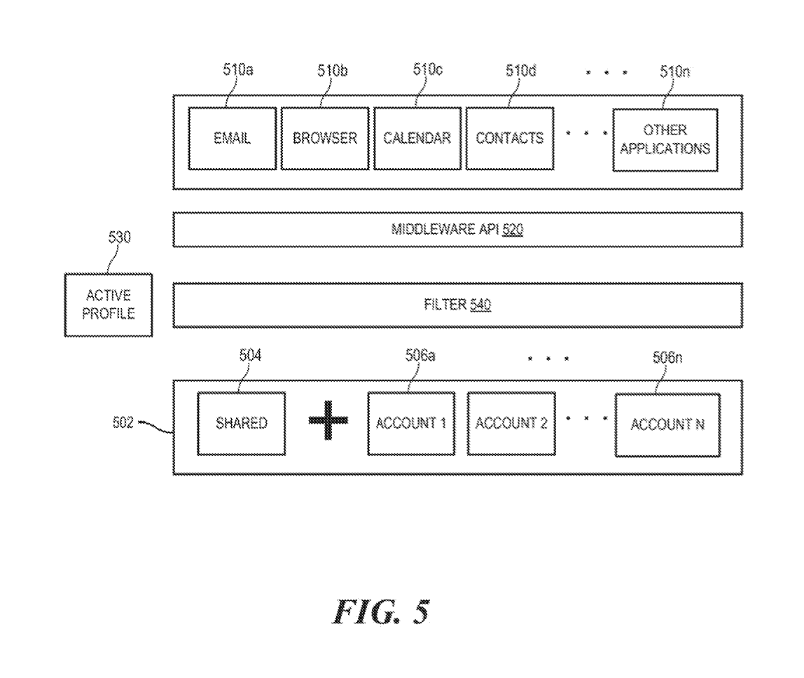

The querying instructions 426 may also be used to receive query results. The results can correspond to the account specific information requested by the query and the one or more accounts associated with the active profile. In one example, the program receives a request from the application for contact information. The active profile is associated with three accounts that include contact information (e.g., two email accounts and an instant messaging account). Further, a shared profile includes family associated contact information. In this example, the database may include contact information associated with other profiles. The contact information associated with the three accounts associated with the active profile as well as the family associated contact intonation is received. Example approaches to determining the results of the query are discussed in FIG. 5.

FIG. 5 is a block diagram of an approach for providing access to information in a database, according to one example. A system 500 for providing access to a database 502 is shown. The database 502 may include shared information 504, which can come from one or more accounts. As previously noted, shared account specific information can be included in the database 502 and can represent one or more accounts. Further, the database 502 can include account specific information about accounts 506a-506n. The setup of the database 502 can vary. In one example, the database 502 can include an organization that includes sub databases associated with accounts. In another example, the database 502 can include sub databases associated with profiles. For example, a sub database can include content associated with each of the accounts associated with a profile.

Further, the database 502 may include fields to tag or mark information. In one example, a tag can be an account identifier. In another example, the tag can be a type of information (e.g., an email, contact information, web cache, etc.) held in the content body. An application 510a-510n can request information from the database 502 via a middleware API 520. Example applications include an email application 510a, a browser application 510b, a calendar application 510c, and a contacts application 510d. The middleware API 520 then determines an active profile 538. As noted above, the active profile 530 can be associated with one or more accounts. Further, the active profile 530 can be determined based on an authentication mechanism.

The middleware API 520 uses a filter 540 to retrieve the information from the database 502. In certain scenarios, the information retrieved includes shared account specific information. Moreover, the information retrieved can include unshared account specific information. In one example, the active profile 530 is a guest profile or shared profile. In this example, the middleware API 520, via the filter 540, retrieves content from the shared information 584 portion of the database 502.

In another example, the active profile 530 is a profile associated with a user. The active profile 530 is associated with one or more accounts. The middleware API 520 can retrieve the information from the database 582 that is associated with the accounts. Further, the middleware API 520 can retrieve information associated with the shared information 504. The filter 540 can be used to filter out information that is unassociated with the accounts associated with the active profile 530.

In certain examples, the middleware API 520 combines information retrieved from multiple accounts 506 as well as the shared information 504. In the case of an email application 510a, the information can include emails associated with the various accounts. The middleware API 520 combines the emails. The emails can also be associated with tags and/or account information. For example, account 1 506a can be associated with a work tag while the shared information is associated with a family or shared tag. Further, the information is provided to the requesting email application 510a. The email application 510a can then present the requested information (e.g., a set of emails) to a user. Additionally or alternatively, other tags can be used to determine access control of information provided to applications. For example, the type of application can be used to filter the information provided to applications (e.g., an email application may have access to contact information, but not to game information). Further, the format of the information provided to the application may be formatted based on one or more standards. For example, a personal storage table (PST) format may be provided to an email application.

What is claimed is:

1. A method comprising:
maintaining a database including shared information and user specific information respectively associated with a plurality of profiles;
providing access to the shared information to a plurality of applications executing in an operating system environment;
selecting one of the profiles; and
providing the access to the user specific information respectively associated with the one profile to the applications.

2. The method of claim 1, further comprising:
determining that the profile is no longer in use; and
removing access of the user specific information associated with the one profile to the applications.

3. The method of claim 2, further comprising:
selecting another one of the profiles; and
providing access of user specific information associated with the other one profile to the applications.

4. The method of claim 1, wherein the shared information includes information associated with one or accounts associated with one or more of the applications.

5. The method of claim 4, wherein the user specific information includes information associated with one or more other accounts associated with the one or more applications.

6. The method of claim 1, wherein access to the user specific information is controlled by filtering out the user specific information in the database for which the one profile does not have access.

7. The method of claim 1, wherein the profile selected using authentication including at least one of: a wireless identifier, biometric information, image recognition, an electronic key, and a personal identification code.

8. The method of claim 1, wherein the applications include at least one of: an electronic mail application, a calendar application, a contacts application, and a web browser application.

9. A device comprising:
a database including shared account specific information and unshared account specific information respectively associated with a plurality of accounts;
an operating system environment including a plurality of applications;
a profile management module to determine an active profile; and
a filtering module to filter access of the unshared account specific information to the applications based on the active profile.

10. The device of claim 9, wherein the applications include an electronic mail application,
wherein the unshared account specific information includes electronic mail storage respectively, associated with the accounts, and
wherein the filtering module filters out the electronic mail storage available to the electronic mail application based on one or more of the accounts corresponding to the active profile.

11. The device of claim 9, wherein the active profile is a guest profile and the unshared account specific information is filtered out.

12. The device of claim 9, wherein the active profile is associated with a set of the accounts,
wherein access to the unshared account specific information associated with the set is provided to one or more of the applications.

13. A non-transitory machine-readable storage medium storing instructions that, if executed by a processor of a device, cause the processor to:
receive a request for account specific it formation from of a plurality of applications;
determine an active profile from a plurality of profiles of the device;
query a database for the account specific information based on the request and the active profile;
wherein the database includes the account specific information, which respectively correspond to a plurality of accounts, and
wherein the active profile corresponds to one or more of the accounts; and
receive query results, wherein the results correspond to the account specific information requested by the query and the one or more accounts.

14. The non-transitory machine-readable storage medium of claim 13, wherein the database includes account specific information that is open to each of the profiles.

15. The non-transitory machine-readable storage medium of claim 13, wherein the account specific information requested by the one application includes compiled information from a plurality of the accounts.
